(19) United States
(12) Patent Application Publication
(10) Pub. No.: US 2018/0018307 A1
(43) Pub. Date: Jan. 18, 2018

(54) METHOD OF RECORDING OPERATIONS AND METHOD OF AUTOMATICALLY EXECUTING OPERATIONS

(71) Applicant: INDUSTRIAL TECHNOLOGY RESEARCH INSTITUTE, Hsinchu (TW)

(72) Inventors: Ching-Hung WU, Taichung City (TW); Yu-Yu LAI, Taichung City (TW); Kuei-Chun LIU, Hsinchu City (TW); Hsiao-Han HUANG, Kaohsiung City (TW); Wei-Chuan LI, Hsinchu City (TW)

(73) Assignee: INDUSTRIAL TECHNOLOGY RESEARCH INSTITUTE, Hsinchu (TW)

(21) Appl. No.: 15/393,002

(22) Filed: Dec. 28, 2016

Related U.S. Application Data
(60) Provisional application No. 62/362,240, filed on Jul. 14, 2016.

(30) Foreign Application Priority Data
Dec. 9, 2016 (TW) 105140802

(51) Int. Cl. G06F 17/22; G06F 17/21

(52) U.S. Cl. CPC G06F 17/2247; G06F 17/212; G06F 17/2241

(57) ABSTRACT

Exemplary embodiments of a method of recording operations and Exemplary embodiments of a method of automatically executing operations are provided. The method of automatically executing operations applied on an electronic device includes: reading an operational log including an operational event, a node identifier, and a record of item layout corresponding to the operational event; receiving information of item layout, which corresponds to the operational frame, from the auxiliary function interface; determining, according to the at least one record of item layout and the information of item layout, whether the record of item layout corresponds to the operational frame; and sending an execution command of operation to the auxiliary function interface for execution of the execution command of operation according to the operational event and the node identifier only when the record of item layout corresponds to the operational frame.

### CROSS-REFERENCE TO RELATED APPLICATIONS

This non-provisional application claims priority under 35 U.S.C. §119(a) on Patent Application No(s). 105140802 filed in Taiwan, R.O.C. on 2016 Dec. 9 and Provisional Patent Application No(s). 62/362,240 filed in U.S.A. on 2016 Jul. 14, the entire contents of which are hereby incorporated by reference.

### TECHNICAL FIELD

The disclosure relates to a method of recoding operations, and a method of automatically executing operations.

### BACKGROUND

Smart phones or tablet computers with wireless network capability have widely been used. Moreover, many service providers release their own mobile apps so that consumers using these mobile apps may easily obtain one or more services of interest through a network. For the financial industry, banks release their own mobile apps of network bank so that users are permitted to set up their own accounts and passwords in one or more network banks. After a user is authenticated to log in a network bank as inputting an ID card number, account ID and password, the user is permitted to execute one or more operations of interest and obtain one or more related services. If a user owning accounts of a number of banks would like to search data in these banks or check whether one or more inter-bank transfers are successful, the user needs to log in different mobile apps of network banks and switch from one app to another one. Therefore, log-in and operation processes become more complicated and take more time.

### SUMMARY

According to one or more embodiments, the disclosure provides a method of recoding operations, applied to an electronic device that includes an auxiliary function interface configured to provide accessibility services, and a display device configured to display an operational frame for providing controllable user interface (UI) items to a user. The UI items have a tree structure relationship therebetween. The auxiliary function interface is further configured to send out operational information according to the UI item that the user operates. The method includes: acquiring the operational information; determining an operational event of the user and the UI item, which corresponds to the operational event, among the UI items and assigning a node identifier to the operational event according to the operational information and the tree structure relationship; and writing the operational event and the node identifier into an operational log.

According to one or more embodiments, the disclosure provides a method of automatically executing operations, applied to an electronic device including an auxiliary function interface configured to execute accessibility services, and a display device configured to display an operational frame providing controllable UI items having a tree structure relationship therebetween. The method of automatically executing operations includes: reading an operational log that comprises at least one operational event, at least one node identifier corresponding to the at least one operational event, and at least one record of item layout corresponding to the at least one operational event; receiving information of item layout, which corresponds to the operational frame, from the auxiliary function interface; determining, according to the at least one record of item layout and the information of item layout, whether the record of item layout corresponds to the operational frame; and sending an execution command of operation to the auxiliary function interface for execution of the execution command of operation according to the at least one operational event and the node identifier only when the at least one record of item layout corresponds to the operational frame.

According to one or more embodiments, the disclosure provides another method of automatically executing operations, applied to an electronic device including an auxiliary function interface configured to execute accessibility services, and a display device configured to display an operational frame providing controllable UI items having a tree structure relationship therebetween. The method of automatically executing operations includes: displaying a second operational frame in response to execution of the first UI item by the electronic device, wherein the second operational frame comprises a plurality of second UI items having a tree structure relationship therebetween; reading an operational log comprising at least one operational event, at least one node identifier corresponding to the at least one operational event, and at least one record of item layout corresponding to the at least one operational event; receiving information of item layout from the auxiliary function interface, and the information of item layout corresponding to the second operational frame; determining, according to the at least one record of item layout and the information of item layout, whether the at least one record of item layout corresponds to the second operational frame; and sending an execution command of operation to the auxiliary function interface according to the at least one operational event and the node identifier for execution of the execution command of operation merely when the second operational frame corresponds to the at least one record of item layout.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of an electronic device according to an embodiment of the disclosure;

FIG. 2 is a schematic view of an operational frame shown by the electronic device in FIG. 1.

FIG. 3 is a schematic view of a node tree illustrating a tree structure relationship in a method of recoding operations according to an embodiment of the disclosure;

FIG. 4 is a flow chart of a method of recoding operations according to an embodiment of the disclosure;

FIG. 5 is a flow chart of step S35 in FIG. 4;

FIG. 6 is a flow chart of a location identifier algorithm used in the method of recoding operations according to an embodiment of the disclosure;

FIG. 7 is a schematic view of an operational frame shown by the electronic device in FIG. 1;

FIG. 8 is a schematic view of a node tree illustrating a tree structure relationship in a method of automatically executing operations according to an embodiment of the disclosure;

FIGS. 9A and 9B illustrate a flow chart of a method of automatically executing operations according to an embodiment of the disclosure;

FIG. 10 is a schematic view of a first operational frame shown by the electronic device in FIG. 1;

FIG. 11 is a schematic view of a second operational frame shown by the electronic device in FIG. 1;

FIG. 12 is a schematic view of a node tree illustrating a tree structure relationship in a method of automatically executing operations according to an embodiment of the disclosure; and

FIGS. 13A and 13B illustrate a flow chart of a method of automatically executing operations according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The term “couple” used in the full text of the disclosure (including the claims) refers to any direct and indirect connections. For example, if a processor is described to be coupled to a storage device, it is interpreted as that the processor is directly connected to the storage device, or the processor is indirectly connected to the storage device through other devices or connection means. Moreover, elements/components/steps with same reference numerals represent same or similar parts in the drawings and embodiments. Elements/components/steps with the same reference numerals in different embodiments may be referenced to the related descriptions.

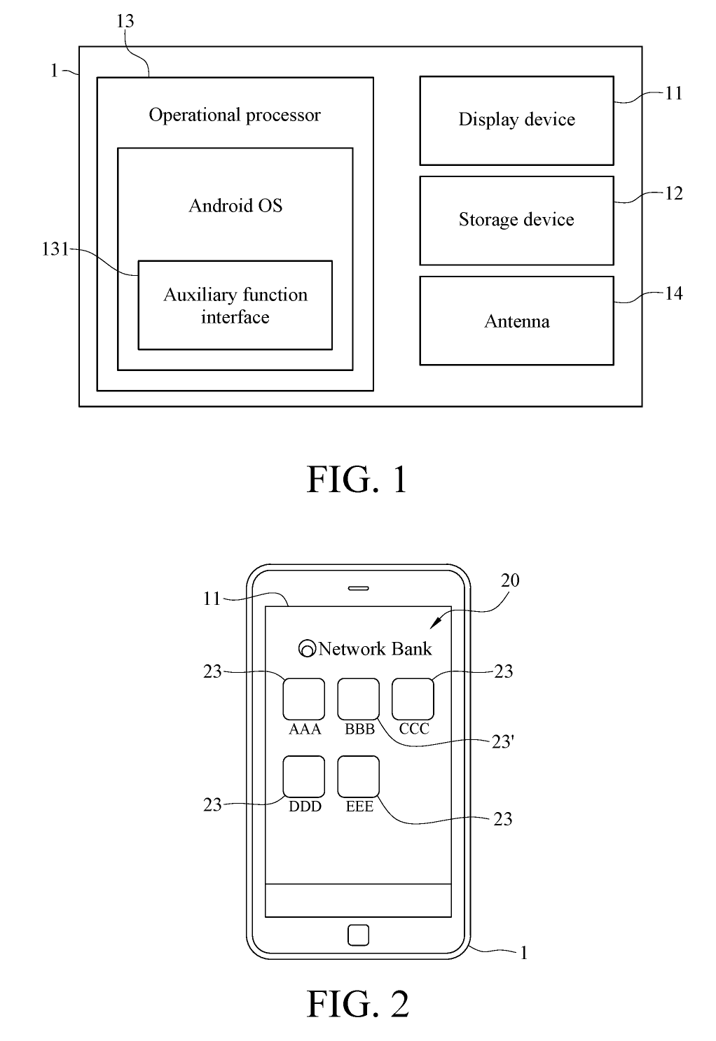

FIGS. 1 and 2 are a block diagram of an electronic device capable of performing a method of recoding operations according to an embodiment of the disclosure, and a frame displayed by the electronic device, respectively. The method of recoding operations is applied to an electronic device 1. The electronic device 1 includes a display device 11, a storage device 12, an antenna 14 capable of receiving and transmitting wireless signals, and an operational processor 13 coupled to the touch display device 11, the storage device 12 and the antenna 14. The operational processor 13 has an auxiliary function interface 131 that is able to execute accessibility services, and the operational processor 13 drives the touch display device 11 to display an operational frame 20. In this embodiment, the display device 11 is an operable display device.

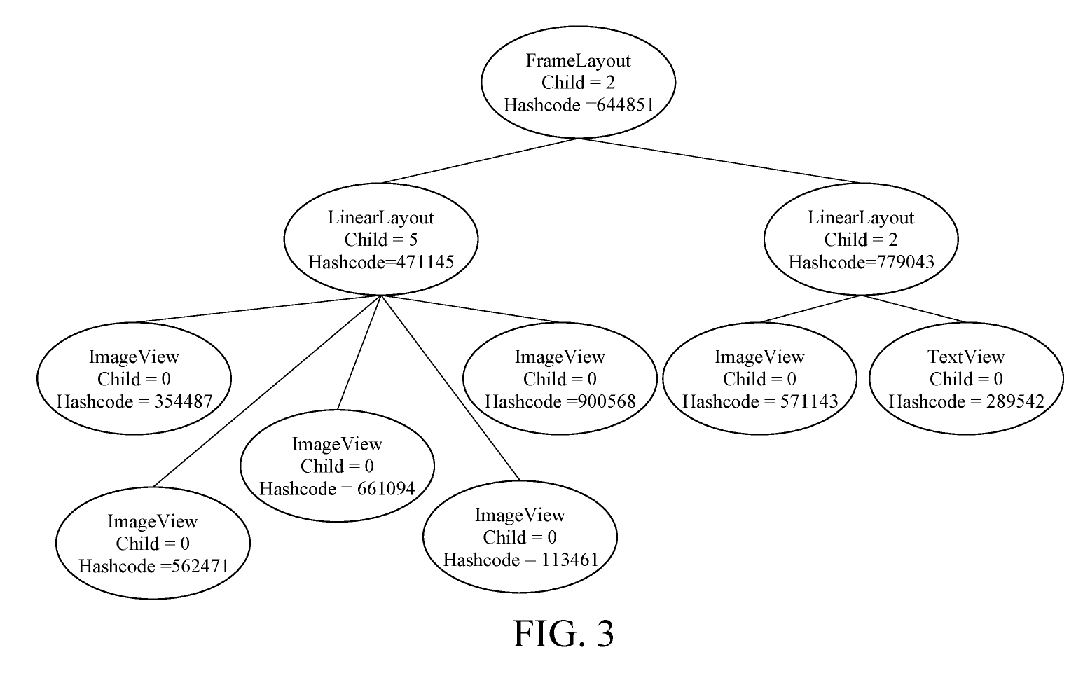

Further refer to FIG. 3, which is a schematic view of a node tree illustrating a tree structure relationship in a method of recoding operations according to an embodiment of the disclosure. The operational frame 20 includes a number of user interface (UI) items 23 configured to be operated by a user. The UI items 23 have the tree structure relationship, as shown in FIG. 3, therebetween, and each UI item 23 is a node in the tree structure relationship. The auxiliary function interface 131 is configured to send operational information according to the UI item operated by the user. In this embodiment, the electronic device 1 is installed with an Android operation system (OS) for operations, and the auxiliary function interface 131 is an Android auxiliary function interface (i.e. Android accessibility service interface).

Under the Android OS, the frame layout is constituted by a variety of displayed items, and the displayed items are, for example, imageview, textview, etc, and the displayed items form a hierarchical relationship therebetween. The UI items 23 in this embodiment are displayed objects of the Android OS.

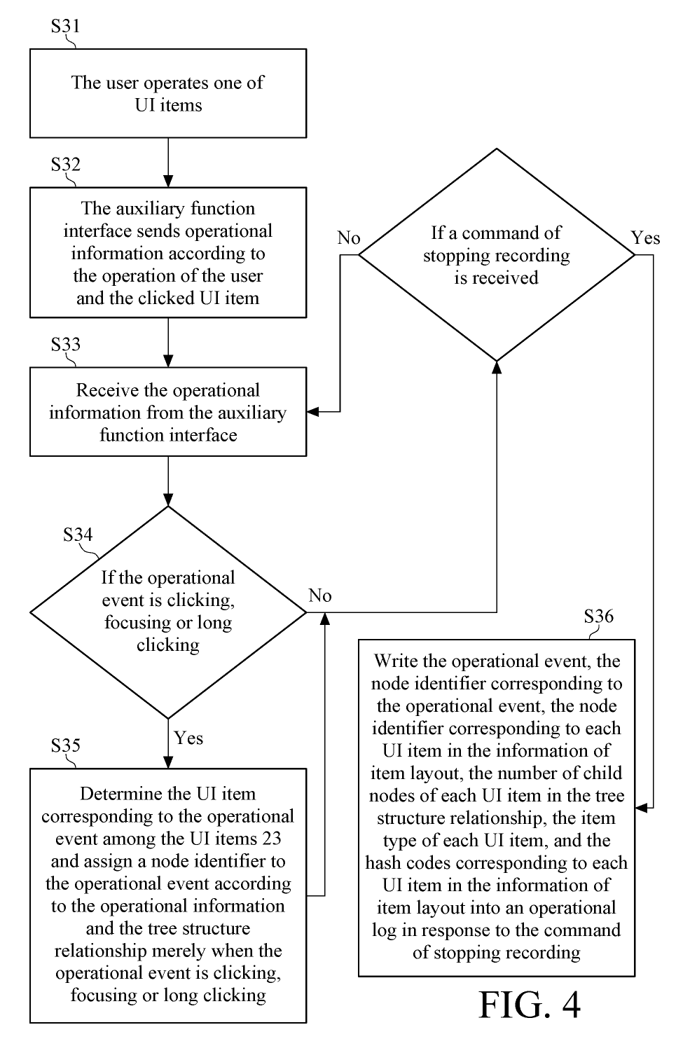

Further refer to FIG. 4, which is a flow chart of a method of recoding operations according to an embodiment of the disclosure. The method of recoding operations includes steps as follows. In step S31, the user operates one of the UI items 23. In this embodiment, the user clicks the UI item “BBB”, represented by 23′. However, the operation actions of the user are not limited to clicking, and other operation actions available to the system may be contemplated in this or some embodiments. The other operation actions may include keying data.

In this embodiment, in step S32 following step S31, the auxiliary function interface 131 sends operational information according to the operation of the user and the clicked UI item 23′. The operational information includes information of item layout (i.e. frame-layout) corresponding to the operational frame 20, an operational event corresponding to the operation of the user, and a hash code corresponding to the executed UI item 23 corresponding to the operational event.

The information of item layout is the information about the operational frame 20, namely the information about all UI items 23 shown in the operational frame 20. The information of item layout includes the item type of each UI item 23 in the operational frame 20, the number of child nodes of each UI item 23 of the operational frame 20 in the tree structure relationship, and a number of hash codes corresponding to each UI item 23 in the operational frame 20. A different operational frame may have its own information of item layout.

Under the Android OS, when the auxiliary function interface intends to send the information of item layout, the auxiliary function interface sends it according to the order of the node location of each UI item so that the tree structure relationship can be obtained according to the number of child nodes and the receiving order. The item type in this embodiment is FrameLayout, LinearLayout, TextView or ImageView defined by the Android OS, wherein FrameLayout is the root node, and LinearLayout is a node having one or more child nodes. In the case of a left node based on a root node in FIG. 3, the item type of the left node is LinearLayout and has 5 children in the tree structure relationship so that the number of child nodes corresponding to the left node is 5 and is marked by “Child=5” in FIG. 3.

In the operational information, the operational event is the information about the operation action of the user. Under the Android OS, the operational event in this embodiment is clicking (TYPE_VIEW_CLICKED), focusing (TYPE_VIEW_FOCUSED), long clicking (TYPE_VIEW_LONG_CLICKED), etc, and the disclosure is not limited to these actions. In the case that the user clicks the UI item 23′ presenting “BBB”, the auxiliary function interface 131 sends information about this click (TYPE_VIEW_CLICKED), the operational event, and sends a hash code, which is 562471, corresponding to the UI item 23′ clicked by the user.

After the auxiliary function interface 131 sends the operational information, step S33 is executed to receive the operational information from the auxiliary function interface 131 and temporarily store the information of item layout, the operational event, and a node identifier corresponding to the operational event in the operational information.

After the information of item layout is received from the auxiliary function interface 131, step S34 is executed to determine whether the operational event is clicking (TYPE_VIEW_CLICKED), focusing (TYPE_VIEW_FOCUSED) or long clicking (TYPE_VIEW_LONG_CLICKED).

Merely when it is determined that the operational event is clicking (TYPE_VIEW_CLICKED), focusing (TYPE_VIEW_FOCUSED) or long clicking (TYPE_VIEW_LONG_CLICKED), step S35 is executed to determine the UI item 23′ corresponding to the operational event among the UI items 23 and assign a node identifier to the operational event according to the operational information and the tree structure relationship.

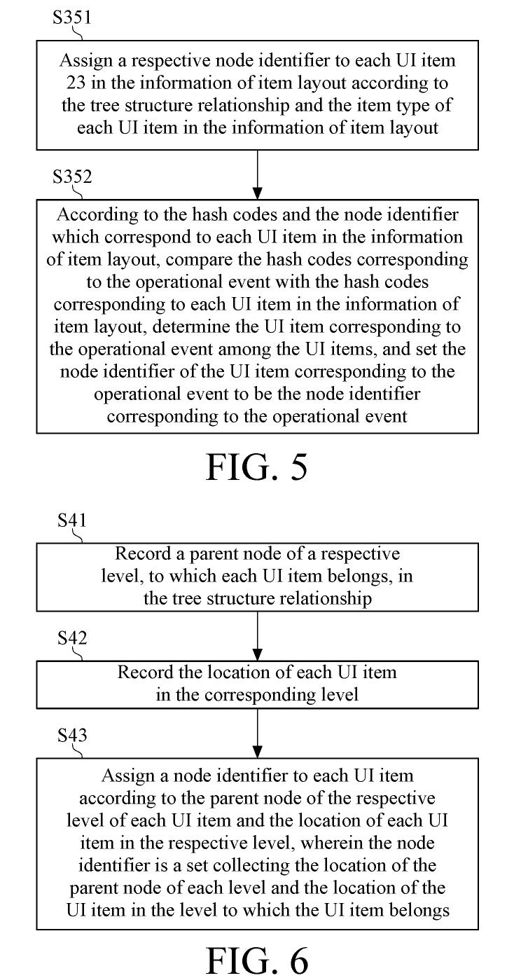

Further refer to FIG. 5, the details of step S35 in this embodiment are described below. In step S351, a location identifier algorithm is executed according to the tree structure relationship and the item type of each UI item 23 in the information of item layout to assign a respective node identifier to each UI item 23 in the information of item layout. Then, step S352 is executed to according to the hash codes and the node identifier which correspond to each UI item 23 in the information of item layout, compare the hash codes corresponding to the operational event with the hash codes corresponding to each UI item 23 in the information of item layout, determine the UI item 23′ corresponding to the operational event among the UI items 23′, and set the node identifier of the UI item 23′ corresponding to the operational event to be the node identifier corresponding to the operational event.

Hereafter, the location identifier algorithm in step S351 is described. Refer to FIG. 6, which is a flow chart of the location identifier algorithm. The location identifier algorithm is used to calculate a node identifier for each UI item 23. In an embodiment, the steps in the location identifier algorithm are listed as follows. Step S41 is executed to record a parent node of a respective level, to which each UI item 23 belongs, in the tree structure relationship. Then, step S42 is executed to record the location of each UI item 23 in the corresponding level. Step S43 is executed to assign a node identifier to each UI item 23 according to the parent node of the respective level of each UI item 23 and the location of each UI item 23 in the respective level. Specifically, the node identifier is a set collecting the location of the parent node of each level and the location of the UI item 23 in the level to which the UI item 23 belongs.

To clarify the location identifier algorithm, the following description is based on the UI item 23′ which is located at the second position in the level to which the UI item 23′ belongs, namely the second position under the LinearLayout. Also, 1 is assigned to represent the code of the node location of the UI item 23′. The parent nodes of the UI item 23′ are FrameLayout and LinearLayout, wherein the parent node of the UI item 23′, FrameLayout, is an empty set assigned by a root level, and the other parent node of the UI item 23′, LinearLayout, is the first position under the root level and “0” is assigned to its position code. The node identifier of the UI item 23′ is set as a set collecting the position code “0” of a parent node and the node position code “1” of the UI item 23′, to mark up the node identifier by [0, 1].

The code for representing a node location is encoded from “0”, so the first position is represented by “0” and the second position is represented by “1”. Various position elements in the node identifier represent different levels. Specifically, the last position element represents the position in the level to which a certain item belongs, and the second last position element represents the position of the parent node in the previous level. The disclosure is not limited to the above the order of encoding and the encoding method. Adjusting the origin of encoding, adding the number of elements in a code, or using symbols except numerals according to the settings and scale of the system may be contemplated in other embodiments. For example, the order of letters is used. Moreover, a respective level represented by each position/element in a set can be adjusted according to the settings of the system. For example, the element at the last position in a set records the position of a parent node.

In the case that the user clicks the UI item 23′ represented by “BBB”, after it is determined in this embodiment that the operational event is clicking (TYPE_VIEW_CLICKED), and the hash code “562471” corresponding to the operational event is received, comparison and searching are performed onto the hash codes of the information of item layout so that the UI item having a hash code “562471” in the information of item layout is considered the UI item 23′ and then it is determined that the UI item 23′ corresponds to the operational event. That is, it is determined that the operation of the user is clicking the UI item 23′. Also, a node identifier [0, 1] of the UI item 23′ is set as a node identifier corresponding to the operational event.

Refer to FIGS. 1, 3 and 4, when a command of stopping recording is received after step S35 is executed to determine whether a command of stopping recording is received, step S36 is executed to write the operational event, the node identifier corresponding to the operational event, the node identifier corresponding to each UI item 23 in the information of item layout, the number of child nodes of each UI item in the tree structure relationship, the item type of each UI item 23, and the hash codes corresponding to each UI item 23 in the information of item layout into an operational log in response to the command of stopping recording. The operational log in this embodiment is a script. When no command of stopping recording is received after step S35 is executed, step S33 is executed.

On the other hand, in step S34, if it is determined that the operational event is not clicking (TYPE_VIEW_CLICKED), focusing (TYPE_VIEW_FOCUSED) or long clicking (TYPE_VIEW_LONG_CLICKED), the determination of whether the command of stopping recording is received is made. If no, step S33 is executed; but if yes, step S36 is executed.

An operational log in an embodiment of the disclosure is exemplified as follows:

```
{
            “event_type”:“TYPE_VIEW_CLICKED”,
            “check_node”:
            [
                {
                    “class_name”:“android.widget.FrameLayout”,
                    “get_node”:[ ],
                    “child_count”:2,
                },
                {
                    “class_name”:“android.widget.LinearLayout”,
                    “get_node”:[0],
                    “child_count”:5,
                },
                {
                    “class_name”:“android.widget.ImageView”,
                    “get_node”:[0, 0],
                    “child_count”:0,
                },
                {
                    “class_name”:“android.widget.ImageView”,
                    “get_node”:[0, 1],
                    “child_count”:0,
                },
                {
                    “class_name”:“android.widget.ImageView”,
                    “get_node”:[0, 2],
                    “child_count”:0,
                },
                {
                    “class_name”:“android.widget.ImageView”,
                    “get_node”:[0, 3],
                    “child_count”:0,
                },
                {
                    “class_name”:“android.widget.ImageView”,
                    “get_node”:[0, 4],
                    “child_count”:0,
                },
                {
                    “timeout”:5000
                }
            ],
            “perform_action”:
            [
                {
                    “action”:“ACTION_CLICK”,
                    “get_node”:[0, 1],
                }
            ]
        },
```

The aforementioned operational log records the information of item layout by the item “check_node”. In the item “check_node”, the information of each UI item 23 records an item type by the item “class_name”, a node identifier by the item “get_node”, the number of child nodes by the item “child_count”, and a hash code by the item “hash_code”. Moreover, the operation of the user is recorded by the item “perform_action”, wherein an operational event is recorded by the item “action”, and a node identifier of a UI item 23 corresponding to the operational event is recorded by the item “get_node”.

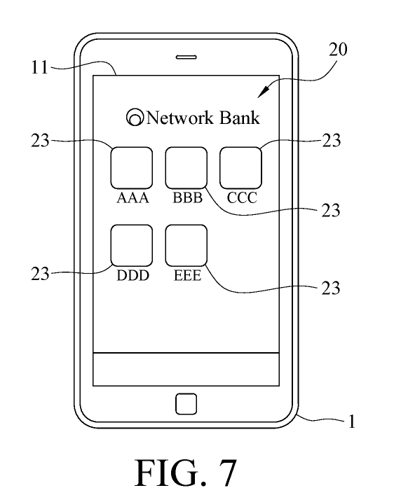

Referring to FIGS. 1 and 7, the method of automatically executing operations in an embodiment of the disclosure is applied to the electronic device 1, as shown in FIG. 1. The electronic device 1 includes a display device 11, a storage device 12, an antenna 14 capable of receiving and transmitting wireless signals, and an operational processor 13 coupled to the display device 11, the storage device 12 and the antenna 14. The operational processor 13 includes an auxiliary function interface 131 configured to execute accessibility services, and drives the touch display device 11 to show an operational frame 20. In this embodiment, the display device 11 is a touch display device.

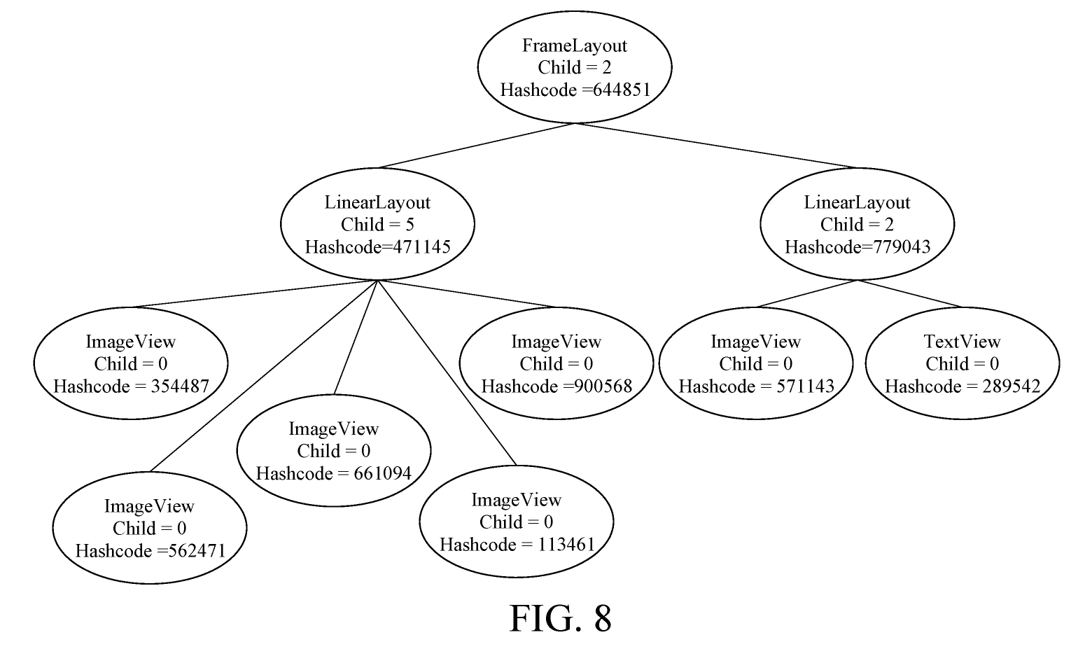

Further refer to FIG. 8, which is a schematic view of a node tree illustrating a tree structure relationship in a method of automatically executing operations according to an embodiment of the disclosure. The operational frame 20 shows a number of UI items 23 configured to be operated by the user. The UI items 23 have the tree structure relationship therebetween. The electronic device 1 in this embodiment is installed with an Android OS for operations, and the auxiliary function interface 131 is an Android auxiliary function interface (Android Accessibility Service Interface).

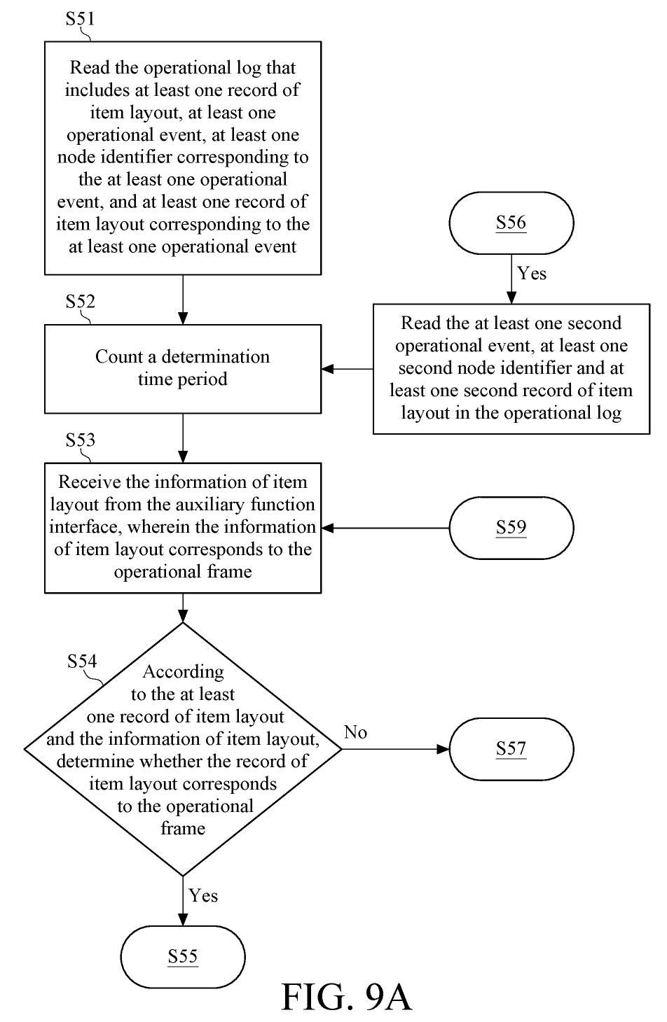

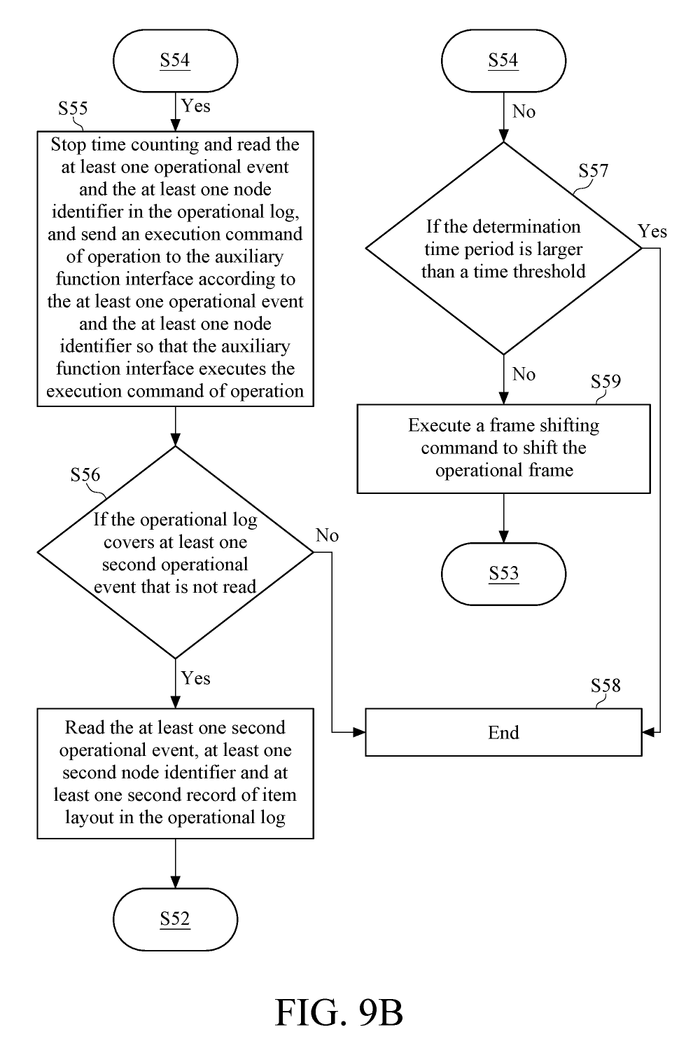

Further refer to FIGS. 9A and 9B, which illustrate a flow chart of a method of automatically executing operations according to an embodiment of the disclosure. The method of automatically executing operations is to automatically execute operations according to an operational log that is produced by the method of recoding operations described in the previous embodiment, as shown in FIGS. 4, 5 and 6. The method of automatically executing operations in an embodiment of the disclosure includes the following steps.

Step S51 is executed to read the operational log that includes at least one record of item layout, at least one operational event, at least one node identifier corresponding to the at least one operational event, and at least one record of item layout corresponding to the at least one operational event. The content of the record of item layout in the operational log is the information about each UI item 23 in a recorded frame, and the record of item layout of the operational log includes the item type, the number of child nodes, a node identifier, and hash codes of each UI item 23 in the recorded frame. The UI items 23 in the recorded frame constitute a recorded tree structure relationship, and the node identifier is a set collecting the information of hierarchical parent node and the node location information.

In the operational log in this embodiment, the at least one operational event includes a first operational event and a second operational event. That is, the operational log in this embodiment records two operation actions. The at least one node identifier includes a first node identifier corresponding to the first operational event, and a second node identifier corresponding to the second operational event. The at least one record of item layout includes a first record of item layout corresponding to the first operational event, and a second record of item layout corresponding to the second operational event. The operational log is produced by the method of recoding operations in the previous embodiment, and the information about the operational log has been described in the previous embodiment and thus, will not be described again.

Step S53 is executed to receive the information of item layout from the auxiliary function interface 131. The information of item layout is the information illustrating the operational frame 20, namely the information about all UI items 23 in the operational frame 20. The information of item layout includes the item type of each UI item 23 in the operational frame 20, the number of child nodes of each UI item 23 of the operational frame 20 in the tree structure relationship, and a number of hash codes of each UI item 23 of the operational frame 20. In this embodiment, the item type is FrameLayout, LinearLayout, TextView or ImageView, defined by the Android OS, FrameLayout is a root node, and LinearLayout is a node having one or more child nodes.

Step S52 is executed to counting a determination time period, and then step S54 is executed to according to the at least one record of item layout of the operational log and the information of item layout sent by the auxiliary function interface 131, determine whether the at least one record of item layout corresponds to the operational frame 20. The determination of a node location indicated by each node identifier of the at least one record of item layout in the tree structure relationship is made according to each node identifier in the at least one record of item layout and the tree structure relationship; and then the determination of the UI items 23 of the information of item layout corresponding to each node identifier of the at least one record of item layout is made according to the node location corresponding to each node identifier of the at least one record of item layout. Afterward, from the at least one record of item layout, the number of child nodes of the UI item 23 corresponding to each node identifier of the record of item layout is obtained; and then, the determination of whether the number of child nodes corresponding to each node identifier of the at least one record of item layout is equal to the number of child nodes of the corresponding UI item 23 in the information of item layout is made.

If yes, it is considered that the at least one record of item layout corresponds to the operational frame 20, and time counting is stopped and reset. Otherwise, the numbers of child nodes of all UI items 23 in the at least one record of item layout are not equal to the numbers of child nodes of the corresponding UI items 23 in the information of item layout, step S57 is executed to determine whether the determination time period is larger than a time threshold. When the determination time period is larger than the time threshold, step S58 is executed to end the method.

Noted that the operational log in this embodiment records two operation actions, namely the first operational event and the second operational event, and this stage is to read and process the first record of item layout corresponding to the first operational event so that the at least one record of item layout described in step S54 is the first record of item layout.

When the number of child nodes of each UI item 23 in the at least one record of item layout is different from the number of child nodes of the corresponding UI item 23 in the information of item layout and the determination time period is not larger than the time threshold, step S59 is executed to execute a frame shifting command (e.g. the command of ACTION_SCROLL_BACKWARD) to shift the operational frame 20. Then, step S53 is executed again to receive the information of item layout from the auxiliary function interface 131, and step S54 is also executed again to determine, according to the at least one record of item layout and the information of item layout, whether the record of item layout corresponds to the operational frame 20. After the frame shifting command is executed, the operational frame 20 accordingly has a change. For example, after the scope of the operational frame 20 is shifted, one or more UI items 23 previously outside the scope of the operational frame 20 may appear in the shifted operational frame 20. In response to the change in the operational frame 20, the auxiliary function interface 131 sends the corresponding information of item layout. In other words, the information of item layout may cover the information of different UI items 23.

Step S55 is executed to send an execution command of operation to the auxiliary function interface 131 according to the operational event and the node identifier merely when the operational frame 20 corresponds to the record of item layout, so the auxiliary function interface 131 executes the execution command of operation.

After it is determined that the operational frame 20 matches the record of item layout, step S55 is executed to stop counting, and read the at least one operational event and the at least one node identifier in the operational log, and then transform the at least one node identifier into the corresponding UI item 23 according to the information of item layout. The operational log in this embodiment records two operation actions, namely the first operational event and the second operational event; and this stage is to read and process the first node identifier corresponding to the first operational event so that the at least one node identifier described in S55 is the first node identifier.

In the case based on the first node identifier represented by [0, 1], the UI item 23 indicated by the first node identifier [0, 1] is the second node following the first node at the second level, and then the UI item 23 corresponding to the first operational event can be obtained according to the information of item layout.

Next, a first execution command of operation is produced and is sent to the auxiliary function interface 131 according to the first operational event and the UI item 23 corresponding to the first node identifier so that the auxiliary function interface 131 further executes the first execution command of operation.

After the first execution command of operation corresponding to the first operational event is executed, step S56 is executed to determine whether the operational log covers a second operational event that is not read. When the second operational event that is not read is not covered, the second operational event, the second node identifier and the second record of item layout are read. Then, the second node identifier is transformed into the corresponding UI item 23 according to the information of item layout, a second execution command of operation is produced and sent to the auxiliary function interface 131 according to the second operational event and the UI item 23 corresponding to the second node identifier so that the auxiliary function interface 131 further executes the second execution command of operation. The operational log in this embodiment records two operation actions, the first operational event and the second operational event, and the stage is to read and process the second node identifier corresponding to the second operational event.

The calculation of determining the UI item 23 corresponding to the second node identifier is the same as that of determining the UI item 23 corresponding to the first node identifier and thus, will not be described again. Since the operational log may record more than one operational event, step S56 is one by one reading and processing the operational events and also checking whether executing a next operational event is needed.

On the other hand, when it is determined that the second operational event that is not read is not covered, step S58 is executed to end the method.

The operational log in this embodiment is exemplified below by a source code except the sections not related to this embodiment:

```
{
            “event_type”:“TYPE_VIEW_CLICKED”,
            “check_node”:
            [
                {
                    “class_name”:“android.widget.FrameLayout”,
                    “get_node”:[ ],
                    “child_count”:2,
                },
                {
                    “class_name”:“android.widget.LinearLayout”,
                    “get_node”:[0],
                    “child_count”:5,
                },
                .....
                {
                    “class_name”:“android.widget.ImageView”,
                    “get_node”:[0, 1],
                    “child_count”:0,
                },
                .....
                {
                    “timeout”:5000
                }
            ],
            “perform_action”:
            [
                {
                    “action”:“ACTION_CLICK”,
                    “get_node”:[0, 2],
                }
            ]
        },
        {
            “event_type”:“TYPE_VIEW_FOCUSED”,
            “check_node”:
            [
                {
                    “class_name”:“android.widget.FrameLayout”,
                    “get_node”:[ ],
                    “child_count”:2,
                },
                {
                    “class_name”:“android.widget.LinearLayout”,
                    “get_node”:[0],
                    “child_count”:5,
                },
                ......
                {
                    “class_name”:“android.widget.ImageView”,
                    “get_node”:[0, 2],
                    “child_count”:0,
                },
                ......
                {
                    “timeout”:5000
                }
            ],
            “perform_action”:
            [
                {
                    “action”:“ACTION_FOCUSED”,
                    “get_node”:[0, 2],
                }
            ]
        }
```

In the above operational log, two sections of “check_node” are respectively the first record of item layout and the second record of item layout, and two sections of “perform_action” records an operational event by the item “action” and a node indicator by the item “get_node”.

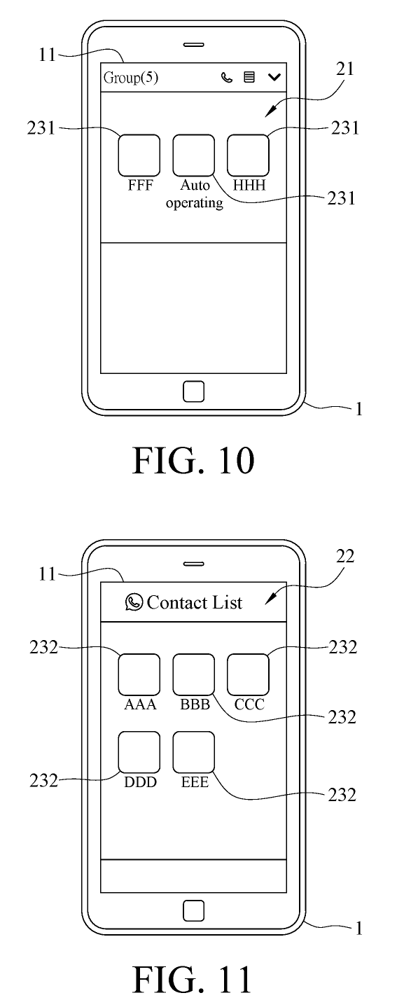

As shown in FIGS. 1 and 10, one embodiment of the method of automatically executing operations is applied to the electronic device 1, as shown in FIG. 1. The electronic device 1 includes a display device 11, a storage device 12, an antenna 14 capable of receiving and transmitting wireless signals, and an operational processor 13 coupled to the touch display device 11, the storage device 12 and the antenna 14. The display device 11 in this embodiment is a touch display device.

The operational processor 13 includes an auxiliary function interface 131 configured to execute accessibility services, and drives the touch display device 11 to display a first operational frame 21. The first operational frame 21 includes a number of UI items 231 configured to be operated by the user. The electronic device 1 in this embodiment is installed with an Android OS, and the auxiliary function interface 131 is an Android auxiliary function interface (i.e. Android accessibility service interface).

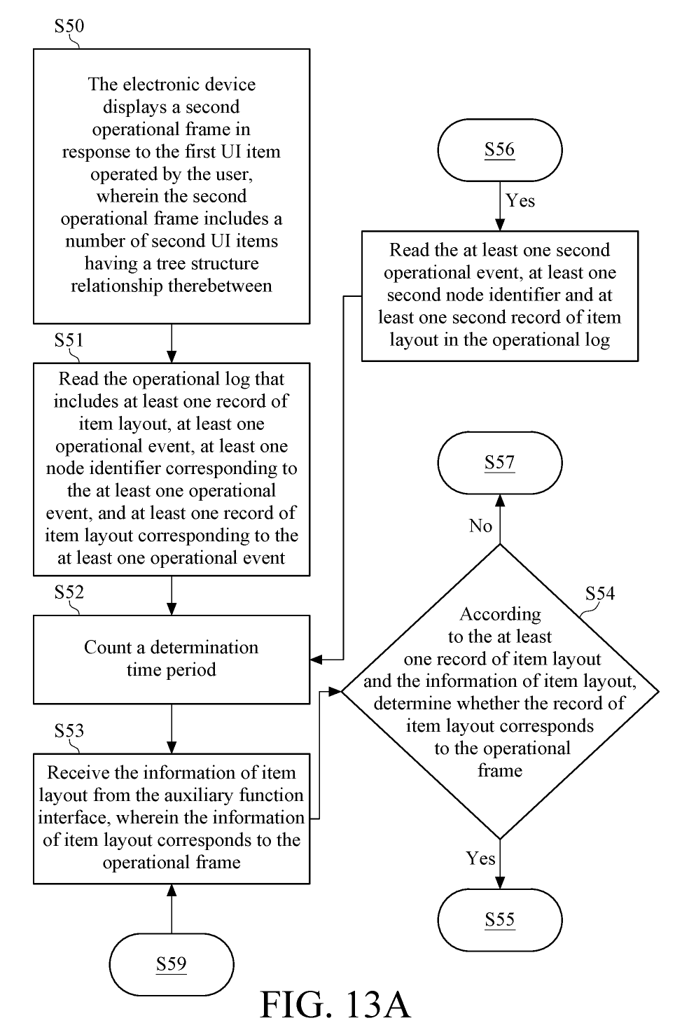

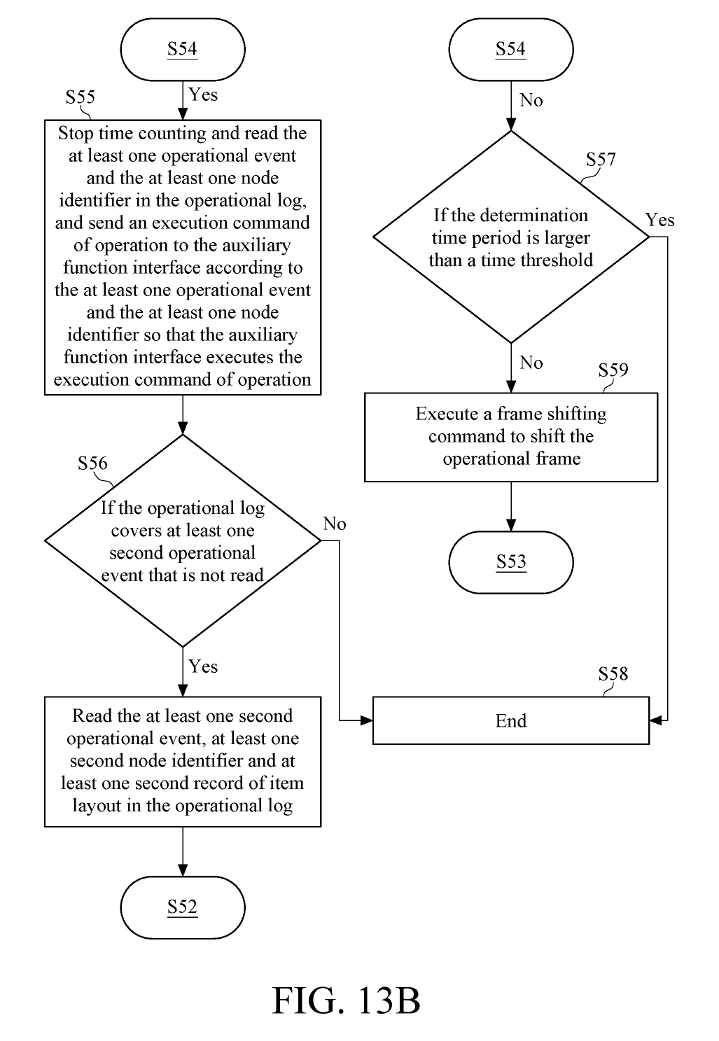

FIG. 11 is a schematic view of a second operational frame 22 shown by the electronic device 1 according to an embodiment of the disclosure. The method of automatically executing operations in this embodiment is similar to the previous embodiment shown in FIGS. 10A and 10B, and both are automatically executing operations according to an operational log which is produced by the method of recoding operations, as shown in FIGS. 4-6. The main difference between this embodiment and the previous embodiment is that the steps in the previous embodiment as shown in FIGS. 9A and 9B are executed in this embodiment after calling the second operational frame 22, as shown in FIG. 13, via the first operational frame 21 is executed.

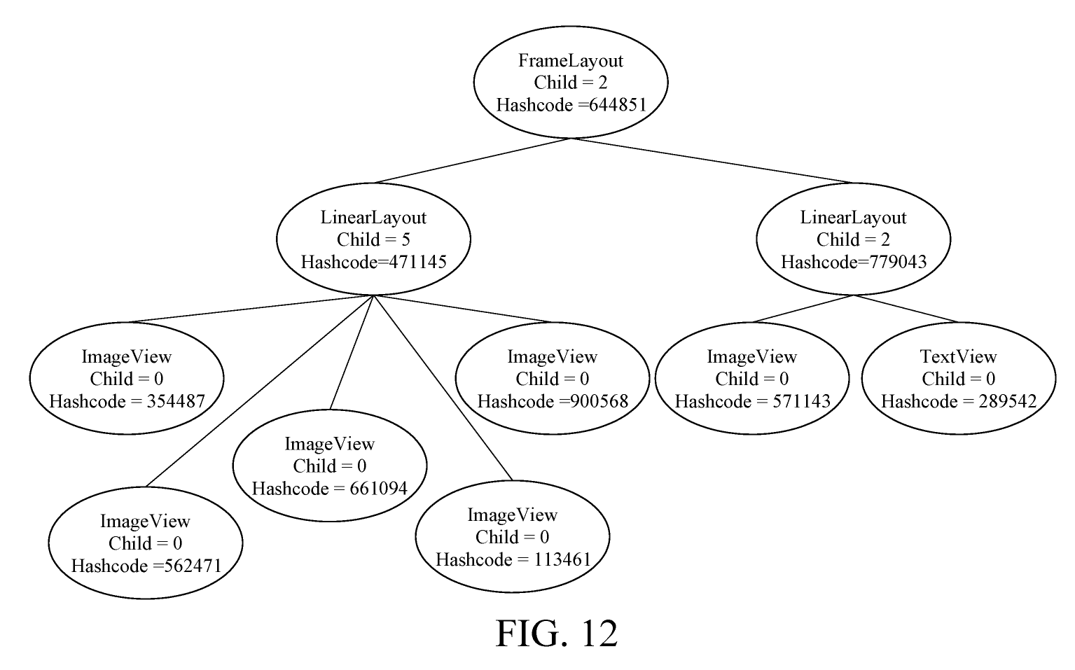

Further refer to FIGS. 12 and 13A-13B. FIG. 12 is a schematic view of a node tree illustrating a tree structure relationship in a method of automatically executing operations according to an embodiment of the disclosure, and FIGS. 13A-13B illustrate a flow chart of a method of automatically executing operations according to an embodiment of the disclosure. The method of automatically executing operations in this embodiment includes the following steps. Step S50 is executed to control the electronic device 1 to display the second operational frame 22 in response to the first UI item 231′ operated by the user. The second operational frame 22 includes a number of second UI items 232, and the second UI items 232 have the tree structure relationship therebetween.

Step S51 is executed to read the operational log, which includes at least one record of item layout, at least one operational event, at least one node identifier corresponding to the at least one operational event, and at least one record of item layout corresponding to the at least one operational event. The content of the record of item layout of the operational log is the information about each UI item 23 in a recorded frame, and includes the item type, the number of child nodes, the node identifier and the hash codes corresponding to each UI item 23 in the recorded frame. In the recorded frame, the UI items 23 form a recorded tree structure relationship, and the node identifier is a set collecting the information of hierarchical parent node and the information of node location.

In the operational log in this embodiment, the at least one operational event includes a first operational event and a second operational event, namely this operational log recording two operation actions. The at least one node identifier includes a first node identifier corresponding to the first operational event, and a second node identifier corresponding to the second operational event. The at least one record of item layout includes a first record of item layout corresponding to the first operational event, and a second record of item layout corresponding to the second operational event. The operational log is produced by the method of recoding operations in the embodiment in relation to FIG. 4. The various information of the operational log has been described in the method of recoding operations in the previous embodiment, and thus, will not be described again hereafter.

Step S53 is executed to receive the information of item layout from the auxiliary function interface 131. The information of item layout sent by the auxiliary function interface 131 corresponds to the second operational frame 22, and the information of item layout is the information about the second operational frame 22, namely the information about all second UI items 232 in the second operational frame 22. The information of item layout includes the item type of each second UI item 232 in the second operational frame 22, the number of child nodes of each UI item 23 of the second operational frame 22 in the tree structure relationship, and a number of hash codes belonging to each second UI item 232 in the operational frame 20. In this embodiment, the item type is FrameLayout, LinearLayout, TextView or ImageView, defined in the Android OS, FrameLayout specifies a root node, and LinearLayout specifies a node having one or more children.

Next, step S52 is executed to count a determination time period and execute the step of determining, according to the at least one record of item layout in the operational log and the information of item layout sent by the auxiliary function interface 131, whether the at least one record of item layout corresponds to the second operational frame 22. The determination of the at least one corresponding second UI item 232 and the number of corresponding child nodes is made according to each node identifier of the at least one record of item layout and the tree structure relationship; and then, the determination of whether the number of child nodes corresponding to each node identifier in the record of item layout is equal to the number of child nodes of the corresponding second UI item 232 in the information of item layout is made.

If yes, it is considered that the at least one record of item layout corresponds to the second operational frame 22, and time counting is stopped and reset. Otherwise, if each of the numbers of child nodes of the at least one record of item layout are not equal to the numbers of child nodes of the corresponding UI items 23 in the information of item layout, step S57 is executed to determine whether the determination time period is larger than a time threshold. When the determination time period is larger than the time threshold, step S58 is executed to end the method of automatically executing operations.

Noted that the operational log in this embodiment records two operation actions, namely the first operational event and the second operational event, and this stage is reading and processing the first record of item layout corresponding to the first operational event so that the at least one record of item layout described in step S54 is the first record of item layout.

If each of the numbers of child nodes of the at least one record of item layout is different from the number of child nodes of the corresponding second UI item 232 in the information of item layout and the determination time period is not larger than the time threshold, step S59 is executed to execute a frame shifting command (e.g. command of ACTION_SCROLL_BACKWARD) to shift the second operational frame 22, and execute step S53 and step S54 again. In this embodiment, the corresponding second UI item 232 and the number of corresponding child nodes are acquired from the information of item layout in accordance with the record of item layout, wherein the transform process, the calculation process, the comparison process, and the determination of whether the information of item layout corresponds to the second operational frame 22 are the same as those in the previous embodiment, as shown in FIGS. 9A and 9B, and thus, will not be described again hereafter.

Step S55 is executed to send an execution command of operation to the auxiliary function interface 131 according to the operational event and the node identifier for execution merely when the second operational frame 22 corresponds to the record of item layout.

After it is determined that the second operational frame 22 matches the record of item layout, step S55 is executed to stop time counting and read the at least one operational event and the at least one node identifier in the operational log, and then transform the at least one node identifier into the corresponding second UI item 232 according to the information of item layout. The operational log in this embodiment records two operation actions, namely the first operational event and the second operational event, and this stage is reading and processing the first node identifier corresponding to the first operational event so that the at least one node identifier described in S55 is the first node identifier. The process and related calculation of the transformation from a node identifier in the operational log to the corresponding second UI item 232 in the information of item layout are the same as those in the previous embodiment and thus, will not be described again hereafter.

Then, a first execution command of operation is produced according to the first operational event and the UI item 23 corresponding to the first node identifier and is sent to the auxiliary function interface 131 so that the auxiliary function interface 131 can further execute the first execution command of operation.

After the first execution command of operation corresponding to the first operational event is executed, step S56 is executed to determine whether the operational log covers the second operational event that is not read. If yes, the second operational event, the second node identifier and the second record of item layout are read. Then, the second node identifier is transformed into the corresponding second UI item 232 according to the information of item layout, and a second execution command of operation is produced according to the second operational event and the second UI item 232 corresponding to the second node identifier and is sent to the auxiliary function interface 131 so that the auxiliary function interface 131 can further execute the second execution command of operation. The operational log in this embodiment records two operation actions, namely the first operational event and the second operational event, and this stage is reading and processing the second node identifier corresponding to the second operational event. On the other hand, if the second operational event not read is not covered, the method of automatically executing operations ends.

In addition, the first operational frame 21 and the second operational frame 22 in this embodiment may be different apps. In other words, the automatical execution of operations is started up via these apps. Therefore, the disclosure can help the user to automatically operate different apps, so as to save the time spent on the switching and operation actions between the apps.

What is claimed is:

1. A method of recoding operations, applied to an electronic device that comprises an auxiliary function interface configured to provide accessibility services, and a display device configured to display an operational frame for providing controllable user interface (UI) items to a user, the UI items having a tree structure relationship therebetween, the auxiliary function interface further configured to send out operational information according to the UI item that the user operates, and the method comprising:
acquiring the operational information;
determining an operational event of the user and the UI item, which corresponds to the operational event, among the UI items and assigning a node identifier to the operational event according to the operational information and the tree structure relationship; and
writing the operational event and the node identifier into an operational log.

2. The method according to claim 1, wherein the operational information comprises information of item layout corresponding to the operational frame, the operational event and a hash code corresponding to the operational event;
the information of item layout comprises hash codes respectively corresponding to the UI items of the operational frame, and item types respectively corresponding to the UI items of the operational frame; and
the assigning the node identifier to the operational event comprises:
respectively assigning the node identifier corresponding to each of the UI items in the information of item layout according to the tree structure relationship and the item type of each of the UI items in the information of item layout; and
comparing the hash code corresponding to the operational event with the hash code corresponding to each of the UI items in the information of item layout, determining the UI item, which corresponds to the operational event, among the UI items, and setting the node identifier of the UI item corresponding to the operational event to be the node identifier corresponding to the operational event according to the hash code corresponding to each of the UI items in the information of item layout and the node identifier corresponding to each of the UI items in the information of item layout.

3. The method according to claim 2, wherein only when the operational event is determined as a click, focusing or a long click, the determining the operational event of the user and the UI item, which corresponds to the operational event, among the UI items according to the operational information and assigning the node identifier according to the UI item corresponding to the operational event and the tree structure relationship is performed.

4. The method according to claim 2, wherein the respectively assigning the node identifier corresponding to each of the UI items in the information of item layout comprises:
recording to a parent node of a level of each of the UI items in the tree structure relationship;
recording a position of each of the UI items in the level to which the UI item belongs; and
assigning the node identifier of each of the UI items according to the parent node of the level of each of the UI items and the position of each of the UI items in the level to which the UI item belongs, wherein the node identifier is a set collecting a position of the parent node of each of the levels and a position of each of the UI items in the level to which the corresponding UI item belongs.

5. The method according to claim 2, further comprising:
temporarily storing the operational event, the node identifier, the information of item layout, and a node identifier corresponding to each of the UI items in the information of item layout; and
writing the node identifier corresponding to each of the UI items in the information of item layout into the operational log.

6. The method according to claim 5, wherein the number of child nodes of each of the UI items is also written into the operational log.

7. The method according to claim 1, wherein the auxiliary function interface is Android auxiliary function interface (Android Accessibility Service Interface).

8. A method of automatically executing operations, applied to an electronic device comprising an auxiliary function interface configured to execute accessibility services, and a display device configured to display an operational frame providing controllable UI items having a tree structure relationship therebetween, and the method comprising:
reading an operational log that comprises at least one operational event, at least one node identifier corresponding to the at least one operational event, and at least one record of item layout corresponding to the at least one operational event;
receiving information of item layout, which corresponds to the operational frame, from the auxiliary function interface;
determining, according to the at least one record of item layout and the information of item layout, whether the record of item layout corresponds to the operational frame; and
sending an execution command of operation to the auxiliary function interface for execution of the execution command of operation according to the at least one operational event and the node identifier only when the at least one record of item layout corresponds to the operational frame.

9. The method according to claim 8, wherein the at least one record of item layout comprises at least one node identifier and at least one number of child nodes corresponding to the at least one node identifier; and
the determining, according to the at least one record of item layout and the information of item layout, whether the at least one record of item layout corresponds to the operational frame, comprises:
determining the UI items respectively corresponding to each one node identifier in the information of item layout and obtaining the number of child nodes of each of the UI items according to each node identifier of the at least one record of item layout;
determining whether the number of child nodes of the at least one record of item layout is equal to the number of child nodes of the corresponding UI item; and
considering that the at least one record of item layout corresponds to the operational frame when the number of child nodes of the at least one record of item layout is equal to the number of child nodes of the corresponding UI item.

10. The method according to claim 9, further comprising:
counting a determination time period,
wherein the determining, according to the at least one record of item layout and the information of item layout, whether the at least one record of item layout corresponds to the operational frame, further comprises:
ending the method when each of the numbers of child nodes of the at least one record of item layout is different from the number of child nodes of the corresponding UI item and the determination time period is larger than a time threshold; and
executing a frame shifting command to shift the operational frame, and then executing the receiving the information of item layout from the auxiliary function interface and the determining, according to the at least one record of item layout and the information of item layout, whether the record of item layout corresponds to the operational frame, when each of the numbers of child nodes of the at least one record of item layout is different from the number of child nodes of the corresponding UI item and the determination time period is not larger than the time threshold.

11. The method according to claim 8, wherein the sending the execution command of operation to the auxiliary function interface according to the at least one operational event so that the auxiliary function interface executes the execution command of operation and the node identifier only when the at least one record of item layout corresponds to the operational frame, further comprises:
transforming the at least one node identifier into a corresponding UI item according to the information of item layout and the tree structure relationship, and sending the execution command of operation to the auxiliary function interface according to the at least one operational event and the UI item corresponding to the at least one node identifier; and
executing the execution command of operation by the auxiliary function interface.

12. The method according to claim 8, wherein the at least one operational event of the operational log comprises a first operational event and at least one second operational event;
the at least one node identifier of the operational log comprises a first node identifier corresponding to the first operational event, and at least one second node identifier corresponding to the at least one second operational event;
the at least one record of item layout of the operational log comprises a first record of item layout corresponding to the first operational event, and at least one second record of item layout corresponding to the at least one second operational event;
the reading the operational log comprises reading the first operational event, the first node identifier, and the first record of item layout; and
the method further comprises:
reading the at least one second operational event, the at least one second node identifier, and the at least one second information of item layout;
determining, according to the at least one second record of item layout that is read and the information of item layout, whether the at least one second record of item layout that is read corresponds to the operational frame; and
sending a second execution command of operation to the auxiliary function interface for execution of the second execution command of operation according to the at least one read second operational event and the at least one read second node identifier merely when the operational frame corresponds to the at least one read second record of item layout.

13. The method according to claim 12, further comprising:
determining whether the operational log covers the at least one second operational event that is not read;
executing the reading the at least one second operational event, the at least one second node identifier, and the at least one second information of item layout when the operational log covers the at least one second operational event that is not read; and
ending the method when the operational log does not cover the at least one second operational event that is not read.

14. The method according to claim 9, wherein the node identifier is a set collecting information of hierarchical parent node and information of hierarchical location; and
the determining the UI items respectively corresponding to each node identifier in the information of item layout and obtaining the number of child nodes of each of the UI items further comprises:
determining a node location indicated by the each node identifier in the tree structure relationship according to the each node identifier and the tree structure relationship; and
obtaining the corresponding UI item according to the indicated node location.

15. The method according to claim 8, wherein the auxiliary function interface is an Android auxiliary function interface.

16. A method of automatically executing operations, applied to an electronic device comprising an auxiliary function interface configured to execute an accessibility service, a display device configured to display a first operational frame comprising at least one first UI item configured to be operated, and the method comprising:
displaying a second operational frame in response to execution of the first UI item by the electronic device, wherein the second operational frame comprises a plurality of second UI items having a tree structure relationship therebetween;
reading an operational log comprising at least one operational event, at least one node identifier corresponding to the at least one operational event, and at least one record of item layout corresponding to the at least one operational event;
receiving information of item layout from the auxiliary function interface, and the information of item layout corresponding to the second operational frame;
determining, according to the at least one record of item layout and the information of item layout, whether the at least one record of item layout corresponds to the second operational frame; and
sending an execution command of operation to the auxiliary function interface according to the at least one operational event and the node identifier for execution of the execution command of operation merely when the second operational frame corresponds to the at least one record of item layout.

17. The method according to claim 16, wherein the at least one record of item layout comprises at least one node identifier and at least one the number of child nodes corresponding to the at least one node identifier; and
the determining, according to the at least one record of item layout and the information of item layout, whether the at least one record of item layout corresponds to the second operational frame, further comprises:
determining the second UI items respectively corresponding to each node identifier in the information of item layout and obtaining the number of child nodes of each of the second UI items according to the each node identifier of the at least one record of item layout;
determining whether each of the numbers of child nodes of the at least one record of item layout is equal to the number of child nodes of the corresponding second UI item; and
considering that the at least one record of item layout corresponds to the second operational frame, when each of the numbers of child nodes of the at least one record of item layout is equal to the number of child nodes of the corresponding second UI item.

18. The method according to claim 17, further comprising:
counting a determination time period,
wherein the determining, according to the at least one record of item layout and the information of item layout, whether the at least one record of item layout corresponds to the second operational frame, further comprises:
ending the method when each of the numbers of child nodes of the at least one record of item layout is different from the number of child nodes of the corresponding second UI item, and the determination time period is larger than a time threshold; and
when each of the numbers of child nodes of the at least one record of item layout is different from the number of child nodes of the corresponding second UI item and the determination time period is not larger than the time threshold, executing a frame shifting command to shift the second operational frame, and then executing the acquiring the information of item layout from the auxiliary function interface and the determining, according to the at least one record of item layout and the information of item layout, whether the at least one record of item layout corresponds to the second operational frame.

19. The method according to claim 16, wherein the sending the execution command of operation to the auxiliary function interface according to the at least one operational event for the execution of the execution command of operation further comprises:
transforming the at least one node identifier into the corresponding second UI item according to the information of item layout and the tree structure relationship, and sending the execution command of operation to the auxiliary function interface according to the at least one operational event and the second UI item corresponding to the at least one node identifier; and
executing the execution command of operation by the auxiliary function interface.

20. The method according to claim 17, wherein the at least one operational event of the operational log comprises a first operational event and at least one second operational event;
the at least one node identifier of the operational log comprises a first node identifier corresponding to the first operational event, and at least one second node identifier corresponding to the at least one second operational event;
the at least one record of item layout in the operational log comprises a first record of item layout corresponding to the first operational event, and at least one second record of item layout corresponding to the at least one second operational event;
the reading an operational log comprises reading the first operational event, the first node identifier, and the first record of item layout; and
the method further comprises:
reading the at least one second operational event, the at least one second node identifier, and the at least one second information of item layout;
determining, according to the at least one read second record of item layout and the information of item layout, whether the at least one read second record of item layout corresponds to the second operational frame; and
sending a second execution command of operation to the auxiliary function interface according to the at least one read second operational event and the at least one read second node identifier, merely when the second operational frame corresponds to the at least one read second record of item layout, so that the auxiliary function interface executes the second execution command of operation.

21. The method according to claim 20, further comprising:
determining whether the operational log covers the at least one second operational event that is not read;
reading the at least one second operational event, the at least one second node identifier, and the at least one second information of item layout when it is determined that the at least one second operational event that is not read is not covered; and
ending the method when it is determined that the at least one second operational event that is not read is covered.

22. The method according to claim 20, wherein the node identifier is a set collecting information of hierarchical parent node and information of hierarchical location; and
the determining the second UI items respectively correspond to each node identifier in the information of item layout and obtaining the number of child nodes of each of the second UI items further comprises:
determining a node location indicated by the each node identifier in the tree structure relationship according to the each node identifier and the tree structure relationship, and obtaining the corresponding second UI item according to the node location that is indicated.

23. The method according to claim 17, wherein the auxiliary function interface is an Android auxiliary function interface.
